(19) United States
(12) Patent Application Publication
(10) Pub. No.: US 2026/0127150 A1
(43) Pub. Date: May 7, 2026

(54) INDEX TABLE CREATION AND DATA QUERY

(71) Applicant: BEIJING OCEANDASE TECHNOLOGY CO., LTD., Beijing (CN)

(72) Inventors: Jianyun SUN, Hangzhou (CN); Zhenjiang Xie, Hangzhou (CN)

(21) Appl. No.: 19/435,473

(22) Filed: Dec. 29, 2025

Related U.S. Application Data
(63) Continuation of application No. PCT/CN2024/128191, filed on Oct. 29, 2024.

(30) Foreign Application Priority Data
Nov. 20, 2023 (CN) 202311552881.3

(51) Int. Cl. G06F 16/22; G06F 16/245

(52) U.S. Cl. CPC G06F 16/221; G06F 16/2282; G06F 16/245

(57) ABSTRACT

One or more implementations of the present specification provide an index table creation method, a data query method, and apparatuses, and relate to the field of database technologies. In the method, an index column to be used for creating an index and a redundant column associated with the index column can be determined in a data table, and an index table is created, where the index table includes the index column and the redundant column, the index column is an index key of the index table, data in the index column is stored in a row-based storage manner, data in the redundant column is stored in a column-based storage manner, and the redundant column in the index table is used to accelerate a data query process for the data table. The solution provided in the present specification can improve both OLAP performance and OLTP performance of a database by using the index table, so that the database can support an application scenario of HTAP.

### TECHNICAL FIELD

One or more implementations of the present specification relate to the field of database technologies, and in particular, to an index table creation method, a data query method, and apparatuses.

### BACKGROUND

In a data processing system, as a data volume increases substantially, service requirements of online analytical processing (OLAP) and online transaction processing (OLTP) may simultaneously exist in the same data table.

Because OLAP and OLTP have distinct characteristics, it is difficult in related technologies to enable the data table to possess both good OLAP performance and OLTP performance. For example, OLAP usually requires to query a certain column or several columns of data in the data table, and OLTP usually requires to query a single row of data in the data table. Therefore, it is difficult to consider query efficiency of both in the related technologies.

### SUMMARY

One or more implementations of the present specification provide an index table creation method, a data query method, and apparatuses.

One or more implementations of the present specification provide the following technical solutions.

According to a first aspect of one or more implementations of the present specification, an index table creation method is proposed, including: determining, in a data table, an index column to be used for creating an index and a redundant column associated with the index column; and creating an index table, the index table including the index column and the redundant column, the index column being an index key of the index table, data in the index column being stored in a row-based storage manner, data in the redundant column being stored in a column-based storage manner, and the redundant column in the index table to be used to accelerate a data query process for the data table.

According to a second aspect of one or more implementations of the present specification, a data query method is proposed, including: obtaining a data query command, the data query command to be used to query a target column of a data table for target data that satisfies a query condition; in response to that the redundant column of the index table includes at least a part of the target column, querying the target column included in the redundant column for a first target row that satisfies the query condition, to obtain a first target row offset, the index table being an index column and the redundant column, the index column being an index key of the index table, data in the index column being stored in a row-based storage manner, and data in the redundant column being stored in a column-based storage manner; and querying, based on the first target row offset, for the target data that satisfies the query condition.

According to a third aspect of one or more implementations of the present specification, an index table creation apparatus is proposed, including: a determining module, configured to determine, in a data table, an index column to be used for creating an index and a redundant column associated with the index column; and a creating module, configured to create an index table, the index table including the index column and the redundant column, the index column being an index key of the index table, data in the index column being stored in a row-based storage manner, data in the redundant column being stored in a column-based storage manner, and the redundant column in the index table to be used to accelerate a data query process for the data table.

According to a fourth aspect of one or more implementations of the present specification, a data query apparatus is provided, including: an acquisition module, configured to obtain obtaining a data query command, the data query command to be used to query a target column of a data table for target data that satisfies a query condition; a first query module, configured to: in response to that the redundant column of the index table includes at least a part of the target column, query the target column included in the redundant column for a first target row that satisfies the query condition, to obtain a first target row offset, the index table including an index column and the redundant column, the index column being an index key of the index table, data in the index column being stored in a row-based storage manner, and data in the redundant column being stored in a column-based storage manner; and a second query module, configured to query, based on the first target row offset, for the target data that satisfies the query condition.

According to a fifth aspect of one or more implementations of the present specification, an electronic device is provided, including: a processor; and a storage, configured to store processor-executable instructions. The processor runs the executable instructions to implement the method according to the first aspect and/or the method according to the second aspect.

According to a sixth aspect of one or more implementations of the present specification, a computer-readable storage medium is provided. The computer-readable storage medium stores computer instructions, and when the instructions are executed by a processor, the steps of the method according to the first aspect and/or the steps of the method according to the second aspect are implemented.

The method provided in the present specification can enable a created index table to include an index column and a redundant column. Data in the index column is stored in a row-based storage manner, and data in the redundant column is stored in a column-based storage manner, so that the index table provided in the present specification can improve both OLAP performance and OLTP performance of a database, to enable the database to support an application scenario of hybrid transaction/analysis processing (HTAP).

### BRIEF DESCRIPTION OF DRAWINGS

FIG. 1 is a schematic flowchart illustrating an index table creation method according to an example implementation.

FIG. 2 is a schematic diagram illustrating a row-based storage manner according to an example implementation.

FIG. 3 is a schematic diagram illustrating a column-based storage manner according to an example implementation.

FIG. 4 is a schematic flowchart illustrating a data query method according to an example implementation.

FIG. 5 is a schematic diagram illustrating a structure of a device according to an example implementation.

FIG. 6 is a schematic diagram illustrating a structure of an index table creation apparatus according to an example implementation.

FIG. 7 is a schematic diagram illustrating a structure of a data query apparatus according to an example implementation.

### DESCRIPTION OF EMBODIMENTS

Example implementations are described in detail herein, and examples of the example implementations are presented in the accompanying drawings. When the following description relates to the accompanying drawings, unless specified otherwise, same numbers in different accompanying drawings represent same or similar elements. The implementations described in the following example implementations do not represent all implementations consistent with one or more implementations of the present specification. On the contrary, the implementations are merely examples of apparatuses and methods consistent with some aspects of one or more implementations of the present specification described in detail in the appended claims.

It should be noted that, in other implementations, the steps of the corresponding method are not necessarily performed in the sequence shown and described in the present specification. In some other implementations, the method can include more or fewer steps than those described in the present specification. In addition, a single step described in the present specification may be broken down into a plurality of steps in other implementations for description, and a plurality of steps described in the present specification may be combined into a single step in other implementations for description.

In a data processing system, as a data volume increases substantially, service requirements of OLAP and OLTP may simultaneously exist in the same data table. An OLAP system and an OLTP system have different characteristics. A row-based storage manner in a database is friendly to OLTP, and a row-based storage manner is more friendly to OLAP.

In order to enable a data table to support both OLAP and OLTP, a same data table is stored twice in a row-based storage manner and a column-based storage manner, which significantly increases storage costs.

The present specification provides an index table creation method that can improve both OLAP performance and OLTP performance of a data table by creating an index table corresponding to the data table.

For example, the present specification first provides an index table creation method. In this method, an index column to be used for creating an index and a redundant column associated with the index column can be determined in a data table. Am index table including the index column and the redundant column is then created. The index is an index key of the index table, data in the index column is stored in a row-based storage manner, and data in the redundant column is stored in a column-based storage manner.

It should be noted that the index table is a special table in a database that is used to store index information. The index table can improve the retrieval efficiency of the database. By sorting and organizing data in advance, a database system can locate and access required data more quickly. When a query is executed, the database can first search the index table for an index key value, and then quickly locate a corresponding data row by using an index pointer, without a need to scan the entire data table row by row.

In the implementations of the present specification, a structure of the index table is improved, so that the index table provided in the implementations of the present specification can improve both OLAP performance and OLTP performance of the data table.

In addition, an implementation of the present specification further provides a data query method, including: obtaining a data query command, the data query command to be used to query a target column of a data table for target data that satisfies a query condition; in response to that the redundant column of the index table includes at least a part of the target column, querying the target column included in the redundant column for a first target row that satisfies the query condition, to obtain a first target row offset; and querying, based on the first target row offset, for the target data that satisfies the query condition. The index table includes an index column and the redundant column, the index column is an index key of the index table, data in the index column is stored in a row-based storage manner, and data in the redundant column is stored in a column-based storage manner. According to this data query method, the index table created in the present specification can be invoked during a data query, so that query efficiency is improved.

An example implementation of the present specification is described in detail below.

First, an implementation of the present specification provides an index table creation method. The method can be performed by any electronic device.

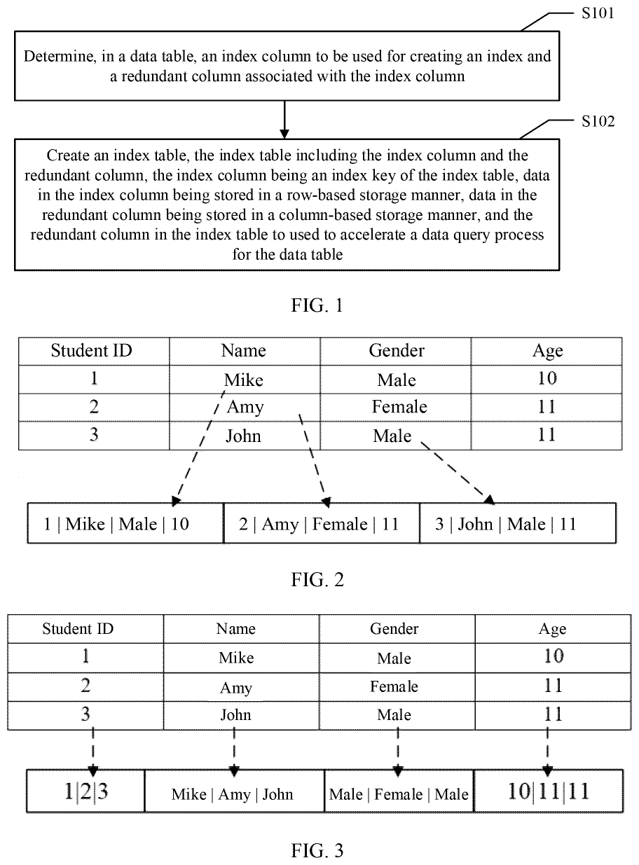

FIG. 1 is a schematic flowchart illustrating an index table creation method according to an example implementation. As shown in FIG. 1, the index table creation method provided in the implementation of the present specification includes the following steps.

S101: Determine, in a data table, an index column to be used for creating an index and a redundant column associated with the index column.

It should be noted that the data table can be any table in a database. For example, the index column and the redundant column can be different fields in the same data table, or can be different fields in different data tables. In addition, there can be one or more index columns and one or more redundant columns. This is not limited in the implementations of the present specification.

In some implementations, the index column can be a field in the data table that is frequently queried. Because the index column is a field used for establishing an index, a query speed of the database for the index column can be improved through the establishment of an index in the index column. For example, the index column can be a field that is frequently used as a query condition in a query process. Through the establishment of an index on the field, data screening efficiency of the database for data in the index column can be improved by using a method such as a binary search method.

Accordingly, the redundant column associated with the index column can be a field that is frequently queried together with the index column, or can be a field on which an OLAP-type query is frequently performed. For example, for a student score table that includes four fields of “Major”, “Grade”, “Name”, and “Score”, “Major” can be used as an index column, to quickly screen out a score of each student in each major. Because “Score” is usually used as a query condition together with “Major”, for example, if a student whose score in a certain major is above 90 is queried, “Score” can be used as a redundant column. In addition, because “Score” can be invoked and queried separately, for example, a pass rate of all students is calculated, if “Score” is used as a redundant column for column-based storage, the above queries can be accelerated.

S102: Create an index table, the index table including the index column and the redundant column, the index column being an index key of the index table, data in the index column being stored in a row-based storage manner, data in the redundant column being stored in a column-based storage manner, and the redundant column in the index table to be used to accelerate a data query process for the data table.

It should be noted that, because the index column is an index key of the index table, rows of data in the index table are sorted based on the index column. Because the redundant column does not have index key constraints, the redundant column does not participate in sorting, and can be understood as a regular field in the table.

For example, there can be one index column, thereby reducing resource overheads for sorting index keys in a process of creating and updating the index table. Other frequently-queried fields can be used as redundant columns. Because the redundant columns are stored in the column-based manner, when data in the redundant columns needs to be separately queried, a certain acceleration query effect can also be provided.

It should be noted that row-based storage means to store values of a same data row together. When a data row is to be inserted or updated, the data row can be directly written into a data block at a time. Therefore, some advantages are possessed in a scenario of frequent writing.

FIG. 2 is a schematic diagram illustrating a row-based storage manner according to an example implementation. FIG. 2 shows a data storage structure of row-based storage using a data table that includes four fields: “Student ID”, “Name”, “Gender”, and “Age”.

Referring to FIG. 2, rows of data in the table are successively written into a data block. A final data storage structure is “1|Mike|Male|10, 2|Amy|Female|11, and 3|John|Male|11”. During a data query, because row-based storage means storage in units of rows, even if only one or several columns of data need to be queried, complete data stored in a disk needs to be read.

It should be noted that column-based storage means to store values of a same data column together. When a data row is to be inserted or updated, values of data columns in the row are also stored at different positions.

FIG. 3 is a schematic diagram illustrating a column-based storage manner according to an example implementation. Similarly, FIG. 3 shows a data storage structure of row-based storage using a data table that includes four fields: “Student ID”, “Name”, “Gender”, and “Age”.

Referring to FIG. 3, columns of data in the table are successively written into a data block. A final data storage structure is “1|2|3, Mike|Amy|John, Male|Female|Male, 10 |11|11”. During a data query, because column-based storage means storage in units of columns, when the query relates to only one or more columns of data in the data table, only data in a corresponding column needs to be read to perform the query.

Therefore, by adding redundant columns to the index table and storing the redundant columns in the column-based storage manner, the index table can be used to accelerate execution of an OLAP request in the database.

For example, a query of an OLAP type may need to access millions of or even billions of data rows, and this type of query is often concerned with only a few data columns. Therefore, when data in the redundant columns are stored in the column-based storage manner, the query of the OLAP type can be accelerated by using the redundant columns.

For example, in an e-commerce sales information statistics table, each data row corresponds to sales information of one type of commodity. Because of a large quantity of types of commodities, a large quantity of data rows may exist. In this case, if the user expects to query the first 20 commodities with the highest sales volume in a year, the query is essentially related to only three data columns: “Time”, “Commodity Name”, and “Sales Volume”. However, for another data column in the e-commerce sales information statistics table, for example, “Commodity Link”, “Commodity Description”, “Chops to Buy the Commodity”, are not related to the query.

In some implementations, “Time”, “Commodity Name”, and “Sales Volume” can be used as redundant columns in the index table in advance for column-based storage. When the above query is executed, the query can be completed by directly reading data columns corresponding to “Time”, “Commodity Name”, and “Sales Volume” from the redundant columns of the index table. Therefore, efficiency of a query in an OLAP large data scenario is significantly improved, and the query is accelerated.

In some implementations, there are a plurality of redundant columns, and the plurality of redundant columns can be stored in a column group (CG) form. For example, values in the plurality of redundant columns are stored in a same data block. When redundant columns used for a query belongs to a same column group, data in the plurality of redundant columns can be read at a time, thereby reducing a quantity of data reads in a query process and reducing read pressure for the disk.

In some implementations, the index table further includes a primary key in the data table, and the primary key and the index column are stored together in the row-based storage manner. Through the addition of the primary key in the data table into the index table, a lookup query can be performed after the index table is hit by using the primary key when a data query range includes a column that does not exist in the index table. For example, the index column in the index table can be the same column as the primary key in the data table. This is not limited in the implementations of the present specification.

Based on the solution provided in the implementations of the present specification, when the index table includes enough redundant columns, cases in which a column that needs to be queried does not exist in the index table can be reduced, thereby reducing the occurrence of a lookup query and further improving query efficiency.

It can be understood that data stored in the row-based storage manner and data stored in the column-based storage manner are respectively located in different data blocks in the present specification. The index column is still stored independently in the row-based storage manner, and can still be queried in a binary search method or the like. Therefore, an OLTP capability of the index table is not affected, and an OLTP query process can still be accelerated.

That is, the index table constructed in the present specification can support acceleration for HTAP, thereby effectively improving performance of the database.

An implementation of the present specification further provides a data query method, as shown in the following implementations. A problem-solving principle of the data query method implementation is similar to that of the index table creation method implementation. Therefore, for an implementation of the data query method implementation, reference can be made to the implementation of the index table creation method implementation. Details are omitted for simplicity.

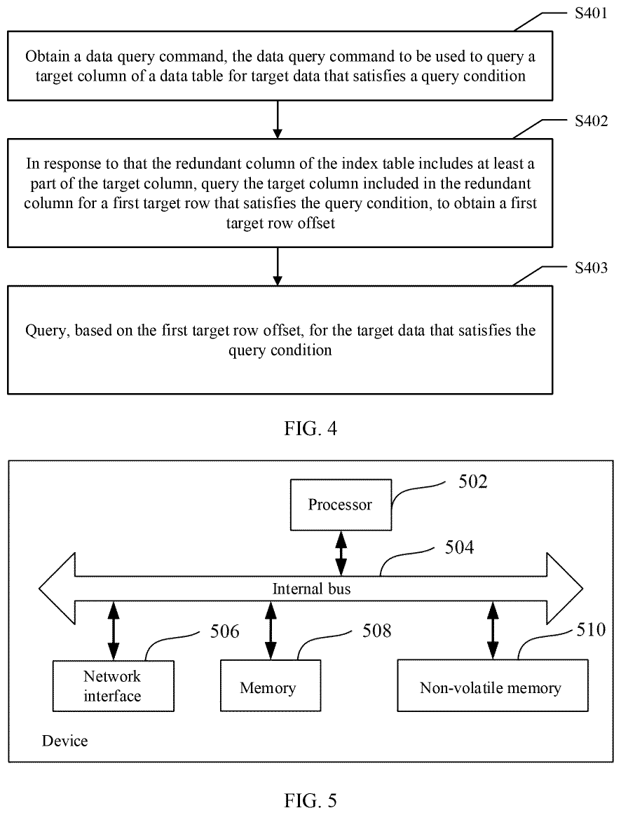

FIG. 4 is a schematic flowchart illustrating a data query method according to an example implementation. The method can be performed by any electronic device. As shown in FIG. 4, the data query method provided in this implementation of the present specification includes the following steps.

S401: Obtain a data query command, the data query command to be used to query a target column of a data table for target data that satisfies a query condition.

It should be noted that the target column can be understood as a column in the data table that is used as a query condition. For example, a student score table includes four fields “Major”, “Grade”, “Name”, and “Score”. Assuming that the data query command is used to query a name of a student whose score is greater than 80, the target column is “Score”.

For example, there can be one or more target columns, and the query condition can be specified by a user according to actual needs. This is not limited in the implementations of the present specification.

S402: In response to that the redundant column of the index table includes at least a part of the target column, query the target column included in the redundant column for a first target row that satisfies the query condition, to obtain a first target row offset.

The index table includes an index column and the redundant column, the index column is an index key of the index table, data in the index column is stored in a row-based storage manner, and data in the redundant column is stored in a column-based storage manner.

It should be noted that for a structure and an effect of the index table, reference can be made to the description in the previous implementation. In the implementations of the present specification, the redundant column includes at least a part of the target column. Therefore, in a process of executing the data query command, a query for the target column can be accelerated by using the redundant column in the index table. It may be understood that in response to that the redundant column includes a plurality of target columns, it means that the index table includes a plurality of redundant columns, and different redundant columns respectively correspond to different target columns in the plurality of target columns.

It should be noted that the first target row offset is a row offset of a first target row. In the index table, although values of rows of data are distributed to different columns, and storage manners of different columns may be different, row offsets of the rows of data in the columns are the same. Therefore, values of a data row in different columns can be determined by a row offset.

In some implementations, in response to that the redundant column includes a plurality of target columns, each target column included in the redundant column can be queried for a candidate row that satisfies the query condition, to obtain a row offset set of candidate rows in each target column. The first target row offset can be obtained by calculating an intersection set of row offset sets corresponding to the target columns in the redundant column.

Because data in the redundant column is stored in the row-based storage manner, when each column is queried, only data of the column needs to be read, so that a query for each column can be quickly completed. Through calculation of the intersection set of the row offset sets corresponding to the target columns, a row offset of a row that satisfies a query condition of each target column can be obtained.

S403: Query, based on the first target row offset, for the target data that satisfies the query condition.

In some implementations, the above student score table is still used as an example. Assuming that the data query command is used to query a name of a student whose score is greater than 80, the target column is “Score”. After a first target row offset of a row in which a score is greater than 80 is determined by using the redundant column, if the index column or the redundant column in the index table includes student name, a student name corresponding to the row in which the score is greater than 80 is directly determined by using the first target row offset from columns including the student name in the index table.

For example, the index table can further include a primary key in the data table, and the primary key and the index column are stored together in the row-based storage manner. When no column including the student name exists in the index table, a primary key value corresponding to the row in which the score is greater than 80 can be determined by using the first target row offset, and the primary key value is mapped to a student name in the data table, so as to complete a query.

In some implementations, in response to that the redundant column includes a part of the target column and the index column includes another part of the target column, rows indicated by the first target row offset can be screened out, based on the first target row offset, from the target column included in the index column. Then, the screened-out rows is queried for a second target row that satisfies the query condition, to obtain a second target row offset. The target data that satisfies the query condition can be queried based on the second target row offset.

For example, that the redundant column includes a part of the target column and the index column includes another part of the target column can be understood as that the redundant column and the index column include all target columns, that is, the index table includes all target columns. In this case, for a method for querying the target data that satisfies the query condition by using the second target row offset, reference can be made to the above method for performing a query by using the first target row offset. Details are omitted in the implementations of the present specification.

For example, that the redundant column includes a part of the target column and the index column includes another part of the target column can be alternatively understood as that the redundant column and the index column cannot cover all target columns, that is, the index table includes only a part of the target column. In this case, the primary key value corresponding to the second target row offset can be determined from the primary key of the index table based on the second target row offset. Then, the data table is queried, based on the primary key value corresponding to the second target row offset, for the target data that satisfies the query condition.

In some implementations, the redundant column may include only a part of the target column, and the index column does not include the target column, which in this case also means that the index table includes only a part of the target column. Similarly, in this case, the primary key value corresponding to the first target row offset can be determined from the primary key in the index table based on the above first target row offset. Then, the data table is queried, based on the primary key value corresponding to the first target row offset, for the target data that satisfies the query condition.

That is, when the index table includes only a part of the target column, the index table can be used to accelerate a query for a target column that can be covered in the index table, and an uncovered target column in the index table is queried through a lookup query.

It can be learned that, regardless of a type of a query, in response to that the redundant column includes at least a part of the target column, the index table created in the implementations of the present specification can accelerate the query.

FIG. 5 is a schematic diagram illustrating a structure of a device according to an example implementation. Referring to FIG. 5, in terms of hardware, the device includes a processor 502, an internal bus 504, a network interface 506, a memory 508, and a non-volatile memory 510, and certainly may further include hardware needed for another function. One or more implementations of the present specification can be implemented in a software-based manner. For example, the processor 502 reads a corresponding computer program from the non-volatile memory 510 into the memory 508, and then runs the computer program. Certainly, in addition to a software implementation, one or more implementations of the present specification do not exclude another implementation, for example, a logic device or a combination of hardware and software. That is, an execution body of the following processing procedure is not limited to each logical unit, and can be hardware or a logic device.

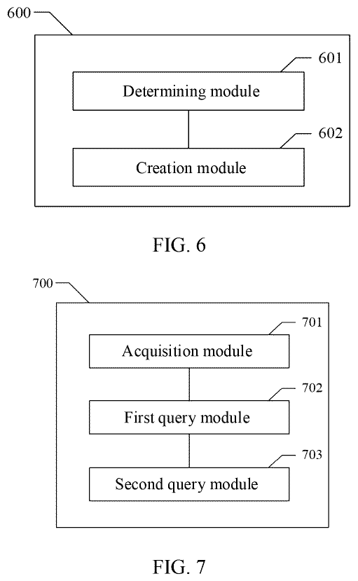

FIG. 6 provides an index table creation apparatus 600, which can be applied to the device shown in FIG. 5 to implement the technical solutions of the present specification. For example, the index table creation apparatus 600 can include: a determining module 601, configured to determine, in a data table, an index column to be used for creating an index and a redundant column associated with the index column; and a creating module 602, configured to create an index table, the index table including the index column and the redundant column, the index column being an index key of the index table, data in the index column being stored in a row-based storage manner, data in the redundant column being stored in a column-based storage manner, and the redundant column in the index table to be used to accelerate a data query process for the data table.

In some implementations, the index table further includes a primary key in the data table, and the primary key and the index column are stored together in a row-based storage manner.

FIG. 7 provides a data query apparatus 700, which can be applied to the device shown in FIG. 5 to implement the technical solutions of the present specification. For example, the data query apparatus 700 can include: an acquisition module 701, configured to obtain obtaining a data query command, the data query command to be used to query a target column of a data table for target data that satisfies a query condition; a first query module 702, configured to: in response to that the redundant column of the index table includes at least a part of the target column, query the target column included in the redundant column for a first target row that satisfies the query condition, to obtain a first target row offset, the index table including an index column and the redundant column, the index column being an index key of the index table, data in the index column being stored in a row-based storage manner, and data in the redundant column being stored in a column-based storage manner; and a second query module 703, configured to query, based on the first target row offset, for the target data that satisfies the query condition.

In some implementations, the first query module 702 is configured to: in response to that the redundant column includes a plurality of target columns, query each target column included in the redundant column for candidate rows that satisfy the query condition, to obtain a row offset set of rows in each target column; and calculate an intersection set of row offset sets corresponding to the target columns in the redundant column, to obtain a first target row offset.

In some implementations, the second query module 703 is configured to: in response to that the redundant column includes a part of the target column and the index column includes another part of the target column, screen out, based on the first target row offset, rows indicated by the first target row offset from the target column included in the index column; query the screened-out rows for a second target row that satisfies the query condition, to obtain a second target row offset; and query, based on the second target row offset, for the target data that satisfies the query condition.

In some implementations, the index table further includes a primary key in the data table, and the primary key and the index column are stored together in a row-based storage manner. The second query module 703 is configured to: in response to that the index table includes a part of the target column, determine, based on the first target row offset, a primary key value corresponding to the first target row offset from a primary key of the index table; and query, based on the primary key value corresponding to the first target row offset, the data table for the target data that satisfies the query condition.

In some implementations, the index table further includes a primary key in the data table, and the primary key and the index column are stored together in a row-based storage manner. The second query module 703 is configured to: in response to that the index table includes a part of the target column, determine, based on the second target row offset, a primary key value corresponding to the second target row offset from the primary key of the index table; and query, based on the primary key value corresponding to the second target row offset, the data table for the target data that satisfies the query condition.

The systems, apparatuses, modules, or units described in the above implementations can be for example implemented by a computer chip or an entity, or can be implemented by a product having a certain function. A typical implementation device is a computer, and a specific form of the computer can be a personal computer, a laptop computer, a cellular phone, a camera phone, a smartphone, a personal digital assistant, a media player, a navigation device, an email receiving/sending device, a game console, a tablet computer, a wearable device, or any combination of several devices in these devices.

In an example configuration, the computer includes one or more processors (CPUs), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The memory may include a non-persistent memory, a random access memory (RAM), a non-volatile memory, and/or another form in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic disk storage, a quantum memory, a graphene-based storage medium, another magnetic storage device, or any other non-transmission medium. The computer storage medium can be configured to store information that can be accessed by a computing device. Based on the definition in the present specification, the computer-readable medium does not include transitory computer-readable media, for example, a modulated data signal and carrier.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product, or device that includes the element.

Example implementations of the present specification are described above. Other implementations fall within the scope of the appended claims. In some cases, the actions or steps described in the claims can be performed in a sequence different from that in the implementations and the desired results can still be achieved. In addition, the process depicted in the accompanying drawings does not necessarily need a particular sequence or a consecutive sequence to achieve the desired results. In some implementations, multi-tasking and parallel processing are feasible or may be advantageous.

The terms used in one or more implementations of the present specification are merely used to describe example implementations, and are not intended to limit the one or more implementations of the present specification. The terms “a” and “the” of singular forms used in one or more implementations of the present specification and the appended claims are also intended to include plural forms, unless otherwise specified in the context clearly. It should be further understood that the term “and/or” used in the present specification indicates and includes any or all possible combinations of one or more associated listed items.

It should be understood that although terms “first”, “second”, “third”, etc. may be used in one or more implementations of the present specification to describe various types of information, the information should not be limited to these terms. These terms are merely used to distinguish between information of the same type. For example, without departing from the scope of one or more implementations of the present specification, first information can also be referred to as second information, and similarly, the second information can also be referred to as the first information. Depending on the context, for example, the word “if” used herein can be explained as “while”, “when”, or “in response to determining”.

The above descriptions are merely example implementations of one or more implementations of the present specification, but are not intended to limit the one or more implementations of the present specification. Any modification, equivalent replacement, improvement, etc. made without departing from the spirit and principle of the one or more implementations of the present specification shall fall within the protection scope of the one or more implementations of the present specification.

1. A method, comprising:
determining, in a data table, an index column and a redundant column associated with the index column; and
creating an index table, the index table including the index column and the redundant column, the index column being an index key of the index table, data in the index column being stored in a row-based storage manner, data in the redundant column being stored in a column-based storage manner.

2. The method according to claim 1, wherein the index table further includes a primary key in the data table, and the primary key and the index column are stored together in the row-based storage manner.

3. The method of claim 1, comprising:
obtaining a data query command, the data query command configured to query a target column of the data table for target data that satisfies a query condition;
in response to that the redundant column of the index table includes at least a part of the target column, querying the target column included in the redundant column for a first target row that satisfies the query condition, to obtain a first target row offset; and
querying, based on the first target row offset, for the target data that satisfies the query condition.

4. The method according to claim 3, wherein the querying the target column included in the redundant column for the first target row that satisfies the query condition, to obtain the first target row offset includes:
in response to that the redundant column includes a plurality of target columns, querying each target column included in the redundant column for a candidate row that satisfy the query condition, to obtain a row offset set of the candidate row in each target column; and
calculating an intersection set of row offset sets corresponding to target columns in the redundant column, to obtain the first target row offset.

5. The method according to claim 3, wherein the querying, based on the first target row offset, for the target data that satisfies the query condition includes:
in response to that the redundant column includes a first part of the target column and the index column includes a second part of the target column, screening out, based on the first target row offset, rows indicated by the first target row offset from the target column included in the index column;
querying the screened-out rows for a second target row that satisfies the query condition, to obtain a second target row offset; and
querying, based on the second target row offset, for the target data that satisfies the query condition.

6. The method according to claim 3, wherein the index table further includes a primary key in the data table, and the primary key and the index column are together stored in the row-based storage manner; and
the querying, based on the first target row offset, for the target data that satisfies the query condition includes:
in response to that the index table includes a part of the target column, determining, based on the first target row offset, a primary key value corresponding to the first target row offset from a primary key of the index table; and
querying, based on the primary key value corresponding to the first target row offset, the data table for the target data that satisfies the query condition.

7. The method according to claim 5, wherein the index table further includes a primary key in the data table, and the primary key and the index column are together stored in the row-based storage manner; and
the querying, based on the second target row offset, for the target data that satisfies the query condition includes:
in response to that the index table includes a part of the target column, determining, based on the second target row offset, a primary key value corresponding to the second target row offset from a primary key of the index table; and
querying, based on the primary key value corresponding to the second target row offset, the data table for the target data that satisfies the query condition.

8. An electronic device, comprising:
one or more processors; and
one or more storage devices, individually or collectively, having processor-executable instructions stored thereon, the processor-executable instructions, when executed by the one or more processors, enabling the one or more processors to, individually or collectively, implement actions including:
determining, in a data table, an index column and a redundant column associated with the index column; and
creating an index table, the index table including the index column and the redundant column, the index column being an index key of the index table, data in the index column being stored in a row-based storage manner, data in the redundant column being stored in a column-based storage manner.

9. The electronic device according to claim 8, wherein the index table further includes a primary key in the data table, and the primary key and the index column are stored together in the row-based storage manner.

10. The electronic device of claim 8, wherein the actions include:
obtaining a data query command, the data query command configured to query a target column of the data table for target data that satisfies a query condition;
in response to that the redundant column of the index table includes at least a part of the target column, querying the target column included in the redundant column for a first target row that satisfies the query condition, to obtain a first target row offset; and
querying, based on the first target row offset, for the target data that satisfies the query condition.

11. The electronic device according to claim 10, wherein the querying the target column included in the redundant column for the first target row that satisfies the query condition, to obtain the first target row offset includes:
in response to that the redundant column includes a plurality of target columns, querying each target column included in the redundant column for a candidate row that satisfy the query condition, to obtain a row offset set of the candidate row in each target column; and
calculating an intersection set of row offset sets corresponding to target columns in the redundant column, to obtain the first target row offset.

12. The electronic device according to claim 10, wherein the querying, based on the first target row offset, for the target data that satisfies the query condition includes:
in response to that the redundant column includes a first part of the target column and the index column includes a second part of the target column, screening out, based on the first target row offset, rows indicated by the first target row offset from the target column included in the index column;
querying the screened-out rows for a second target row that satisfies the query condition, to obtain a second target row offset; and
querying, based on the second target row offset, for the target data that satisfies the query condition.

13. The electronic device according to claim 10, wherein the index table further includes a primary key in the data table, and the primary key and the index column are together stored in the row-based storage manner; and
the querying, based on the first target row offset, for the target data that satisfies the query condition includes:
in response to that the index table includes a part of the target column, determining, based on the first target row offset, a primary key value corresponding to the first target row offset from a primary key of the index table; and
querying, based on the primary key value corresponding to the first target row offset, the data table for the target data that satisfies the query condition.

14. The electronic device according to claim 12, wherein the index table further includes a primary key in the data table, and the primary key and the index column are together stored in the row-based storage manner; and
the querying, based on the second target row offset, for the target data that satisfies the query condition includes:
in response to that the index table includes a part of the target column, determining, based on the second target row offset, a primary key value corresponding to the second target row offset from a primary key of the index table; and
querying, based on the primary key value corresponding to the second target row offset, the data table for the target data that satisfies the query condition.

15. A computer-readable storage medium, having computer instructions stored thereon, the computer instructions, when executed by one or more processors, enabling the one or more processors to, individually or collectively, implement actions including:
determining, in a data table, an index column and a redundant column associated with the index column; and
creating an index table, the index table including the index column and the redundant column, the index column being an index key of the index table, data in the index column being stored in a row-based storage manner, data in the redundant column being stored in a column-based storage manner.

16. The storage medium according to claim 15, wherein the index table further includes a primary key in the data table, and the primary key and the index column are stored together in the row-based storage manner.

17. The storage medium of claim 15, wherein the actions include:
obtaining a data query command, the data query command configured to query a target column of the data table for target data that satisfies a query condition;
in response to that the redundant column of the index table includes at least a part of the target column, querying the target column included in the redundant column for a first target row that satisfies the query condition, to obtain a first target row offset; and
querying, based on the first target row offset, for the target data that satisfies the query condition.

18. The storage medium according to claim 17, wherein the querying the target column included in the redundant column for the first target row that satisfies the query condition, to obtain the first target row offset includes:
in response to that the redundant column includes a plurality of target columns, querying each target column included in the redundant column for a candidate row that satisfy the query condition, to obtain a row offset set of the candidate row in each target column; and
calculating an intersection set of row offset sets corresponding to target columns in the redundant column, to obtain the first target row offset.

19. The storage medium according to claim 17, wherein the querying, based on the first target row offset, for the target data that satisfies the query condition includes:
in response to that the redundant column includes a first part of the target column and the index column includes a second part of the target column, screening out, based on the first target row offset, rows indicated by the first target row offset from the target column included in the index column;
querying the screened-out rows for a second target row that satisfies the query condition, to obtain a second target row offset; and
querying, based on the second target row offset, for the target data that satisfies the query condition.

20. The storage medium according to claim 19, wherein the index table further includes a primary key in the data table, and the primary key and the index column are together stored in the row-based storage manner; and
the querying, based on the second target row offset, for the target data that satisfies the query condition includes:
in response to that the index table includes a part of the target column, determining, based on the second target row offset, a primary key value corresponding to the second target row offset from a primary key of the index table; and
querying, based on the primary key value corresponding to the second target row offset, the data table for the target data that satisfies the query condition.
